(19) United States
(12) Patent Application Publication
(10) Pub. No.: US 2015/0000309 A1
(43) Pub. Date: Jan. 1, 2015

(54) CRYOGEN PUMP

(71) Applicant: IceCure Medical Ltd., Caesarea (IL)

(72) Inventors: Nir Berzak, Tel Aviv (IL); Simon Sharon, Maayan Zvi (IL); Michael Voloshin, Haifa (IL); Ron Hilleli, Zichron Yaacov (IL)

(21) Appl. No.: 14/484,477

(22) Filed: Sep. 12, 2014

Related U.S. Application Data
(62) Division of application No. 13/718,220, filed on Dec. 18, 2012.

(51) Int. Cl. B01D 8/00

(52) U.S. Cl. CPC B01D 8/00
USPC 62/55.5

(57) ABSTRACT

A cryogen pump, including: a pump section that includes: a bellow with an inlet opening at a first end and an exit opening, the inlet opening in direct fluid communication with a volume of a cryogen, the exit opening at least in fluid communication with a second end of the bellow opposing the first end, a pair of plugs configured to sealingly close the opposing ends of the bellow, the pair of plugs cooperating so that when one plug sealingly closes one of the ends, the other end of the bellow is open; and a drive section configured to drive the pump section in a reciprocating manner so as to move the plugs.

### BACKGROUND

1. Field of the Invention

Embodiments of the present invention relate generally to cryogenic pumps and, more particularly, to submerged or insulated cryogenic pumps.

2. Description of Related Art

Handling cryogen fluid at, or slightly below its boiling temperature, which is well below room temperature, can be cumbersome due to the creation of two-phase Condition with any heat absorbed from the environment. Liquid nitrogen, as a cryogen, has additional handling difficulties associated with the Leidenfrost effect and the 700 fold volume expansion from liquid to gas.

As is conventionally known, liquid nitrogen has characteristics that make it difficult to fill a volume. This difficulty is due to the Lindenfrost effect, by which a cushion of vapor results whenever the liquid comes into contact with a surface with a temperature higher than the boiling temperature.

The change of pressure may be another source of difficulties related to the physical state of the fluid. First, it makes it difficult to press the fluid since gaseous phase is compressible. Second, other effect is behavior of liquid nitrogen under vacuum condition. It is very difficult to suck liquid nitrogen. Under vacuum conditions, the boiling temperature decreases, which make the surface temperature higher than the boiling temperature and the above-mentioned effect, come again into play.

One approach to compensate for these issues is the strategic selection of components for fluid cryogenic system.

Applying bellows for several fluid systems components is known.

For example, bellow valves are disclosed in U.S. Patent Publication No. 2011/0067879 A1 and U.S. Pat. No. 4,838,462. Dispensing fluid from a bottle or container is disclosed in International Patent Publication Nos. WO 94/07113, and WO 97/15223.

The application of a bellow for pumping liquid is disclosed in, for example, the following U.S. Pat. Nos.: 3,598,505; 4,310,104; 4,817,688; 4,902,206; 5,165,866; 5,308,230; and 5,655,893. The application of a bellow for pumping liquid is also disclosed in, for example, the following U.S. Patent Publications: US2004/0265149 A1; US 2005/0031475 A1; 2006/0165541 A1; and 2011/0318207 A1, as well as International Patent Publication WO 01/91911 A1.

Further, submerged pumps are disclosed in, for example, U.S. Pat. Nos. 4,472,946, and 4,860,545. A bellow submerged pump is disclosed in, for example, U.S. Pat. No. 7,192,426 B2.

A vacuum bellows is disclosed in U.S. patent application Ser. No. 6,268,995 B1.

In these examples of related art, the main emphasis was on the mechanisms for pumping force and efficiency of the motion. However the application of simple check valves for controlling the inlet and outlet fluid is common.

The foregoing is intended to be illustrative discussion rather an exhaustive one.

### BRIEF SUMMARY

Embodiments of the present invention provide an approach by which the inlet valve and suction condition are eliminated. Filling of a cylinder or a bellow with the pumped cryogenic liquid such as liquid nitrogen is done by creating conditions of communicating vessels, i.e. by gravitational force, without suction, or the need to lower pressure in the cylinder or the bellow, bellow the atmospheric pressure, or the pressure of the filling tank. Additionally, embodiments of the present invention reduce or eliminate the effect of the ambient temperature by vacuum insulating the cylinder or the bellow, thus eliminating the need to submerge the pumping unit into the cryogenic liquid.

An aspect of the present invention provides a cryogen pump having: a pump section that includes: a bellow with an inlet opening at a first end and an exit opening, the inlet opening in direct fluid communication with a volume of a cryogen, the exit opening at least in fluid communication with a second end of the bellow opposing the first end, a pair of plugs configured to sealingly close the opposing ends of the bellow, the pair of plugs cooperating so that when one plug sealingly closes one of the ends, the other end of the bellow is open; and a drive section configured to drive the pump section in a reciprocating manner so as to move the plugs.

Another aspect of the present invention provides a cryogen pump having: a pump section that includes a cylinder having an inlet opening in communication with a cryogen and an exit valve, a piston configured to travel reciprocally in the cylinder along a travel axis therein between a load condition in which the piston is at a position of minimum displacement and the cryogen flows into the cylinder via the inlet opening and a compressing condition in which the piston is at a position of maximum displacement, cryogen does not flow into the cylinder, and cryogen in the cylinder is compressed and pressed out of the exit valve; and a drive section configured to drive the pump section in a reciprocating manner so as to move the piston.

This Summary is provided to introduce a selection of concepts in a simplified form that are further described below in the Detailed Description. This Summary is neither intended to identify key features or essential features of the claimed subject matter, nor should it be used to limit the scope of the claimed subject matter. Furthermore, the claimed subject matter is not limited to implementations that solve any disadvantage noted in any part of this application.

The aforementioned and/or other features, aspects, details, utilities, and advantages of the present invention are: set forth in the detailed description which follows and/or illustrated in the accompanying drawings; possibly inferable from the detailed description and/or illustrated in the accompanying drawings; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is a schematic cross-sectional view of a pumping unit consistent with an exemplary embodiment of the present invention;

FIG. 2 is a schematic cross-sectional view of a pumping unit consistent with another exemplary embodiment of the present invention;

FIG. 3 is a schematic cross-sectional view of a pumping unit consistent with another embodiment of the present invention;

FIG. 4A is a schematic cross-sectional view of a pumping unit consistent with an embodiment of the present invention; and

FIG. 4B is detailed schematic cross-section view of the piston seen in FIG. 4A;

FIG. 5A is a schematic cross-sectional view of a pumping unit consistent with another embodiment of the present invention; and

FIG. 5B is detailed schematic cross-section view of the piston seen in FIG. 5A;

FIG. 6A is a schematic illustration of a piston optionally usable in any of the pumping units of FIGS. 4A and 5A; and

FIG. 6B is detailed schematic cross-section view of the piston seen in FIG. 6A;

FIG. 7 is a schematic cross-sectional view of an alternative driving section that is optionally usable in any of the pumping units of FIGS. 1-3, 4A and 5A; and

FIG. 8 is a schematic cross-sectional view of yet another alternative drive section that is optionally usable in any of the pumping units of FIGS. 1-3, 4A and 5A.

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

The drawings are generally not to scale. For drawing clarity, non-essential elements may have been omitted from some of the drawings.

Although the following text sets forth a detailed description of at least one embodiment or implementation, it is to be understood that the legal scope of protection of this application is defined by the words of the claims set forth at the end of this disclosure. The detailed description is to be construed as exemplary only and does not describe every possible embodiment since describing every possible embodiment would be impractical, if not impossible. Numerous alternative embodiments and/or implementations are both contemplated and possible, using either current technology or technology developed after the filing date of this patent, which would still fall within the scope of the claims.

It is to be understood that, unless a term is expressly defined in this application using the sentence “As used herein, the term” is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

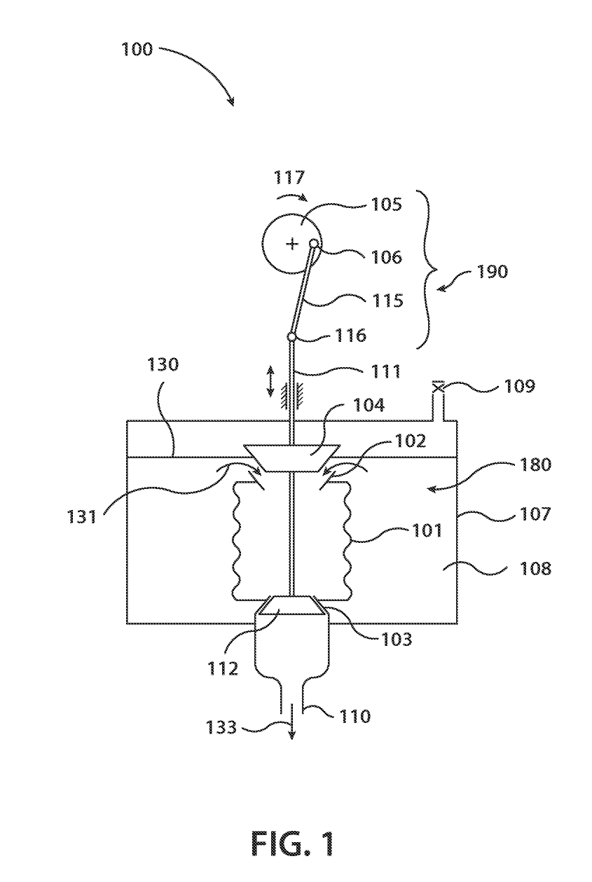

Referring now to FIG. 1, there is shown a pumping unit 100 consistent with an embodiment of the present invention. The pumping unit 100 includes: a driving section 190, a container 107 and pumping element 180. Generally, pumping unit 100 is used for pumping cryogen to a cryosurgical device such as, by way of non-limiting example, a cryogenic medical treatment probe (not shown) which is connected to its outlet 110.

The driving section 190 is a crank-follower mechanism that includes: a rotating wheel 105 connected to a link 115 via a bearing 106 at an end of the link; and a follower 111 connected to another end of the link 115 via a bearing 116.

The pumping section 180 includes: inlet plug 104, valve seat 102, bellow 101, valve seat 103, and outlet plug 112 and is driven by the back and forth motion of follower 111.

The bellow 101 includes an inlet valve seat 102 and is submerged in a cryogen 108. The inlet valve seat 102 is below the surface 130 of the cryogen 108 so that when inlet plug 104 travels away from the inlet seat 102 (upward as illustrated in FIG. 1), cryogen 108 flows 131 into the bellow 101. It should be noted that surface 130 of the cryogen 108 may be well above inlet plug 104. At the other end of the bellow 101, opposing the end with inlet opening 102 is an outlet valve seat 103 that is not in direct fluid communication with the cryogen 108. Bellow 101 is mechanically connected to container 107 at or near outlet valve seat 103. Relief valve 109 allows evaporation of the cryogenic fluid 108, and maintains atmospheric pressure (or pressure slightly above atmospheric pressure) in the container 107. Preferably, container 107 is thermally insulated as known in the art of cryogenics.

When outlet plug 112 travels away from outlet opening 103 of bellow 101 (downward as illustrated in FIG. 1), fluid in bellow 101 may exits through outlet opening 103.

In operation, as the wheel 105 turns, for example in direction 117, such that bearing 106 is moving up, for example, the link 115 which is connected to wheel 105 via bearing 106, forces the follower 111, which is connected to link 115 via bearing 116, to move up. Follower 111 pulls both inlet plug 104 and outlet plug 112 upwards such that inlet opening 102 is opened and cryogen 108 enters 131 bellows 101 by gravitational force due to the condition of communicating vessels created between inner volume of bellows 101 and container 107.

As wheel 105 continues to turn such that bearing 106 reaches its highest position and starts to descend, follower 111 pushes down inlet plug 104 and outlet plug 112, closing inlet opening 102 and opening outlet opening 103. As follower 111 continues to descend, bellows 101 is compressed under the pressure of inlet plug 104 and the cryogen in the bellows is forced through the now opened outlet valve seat 103 and flows 133 through outlet 110.

As wheel 105 continues to turn such that bearing 106 reaches its lowest position and starts to ascend, the refilling of bellows 101 is repeated as disclosed above. During the ascent of inlet plug 104 bellows 101 expand due to its flexibility to accept the inflow 131 of cryogen 108.

Keeping driving section 190 out of container 107, and specifically keeping the motor (not seen in these figures) that rotates wheel 105 outside the cold environment may reduce heat leaks into the container and heat generation inside the container, thus reducing evaporation and waste of the cryogen.

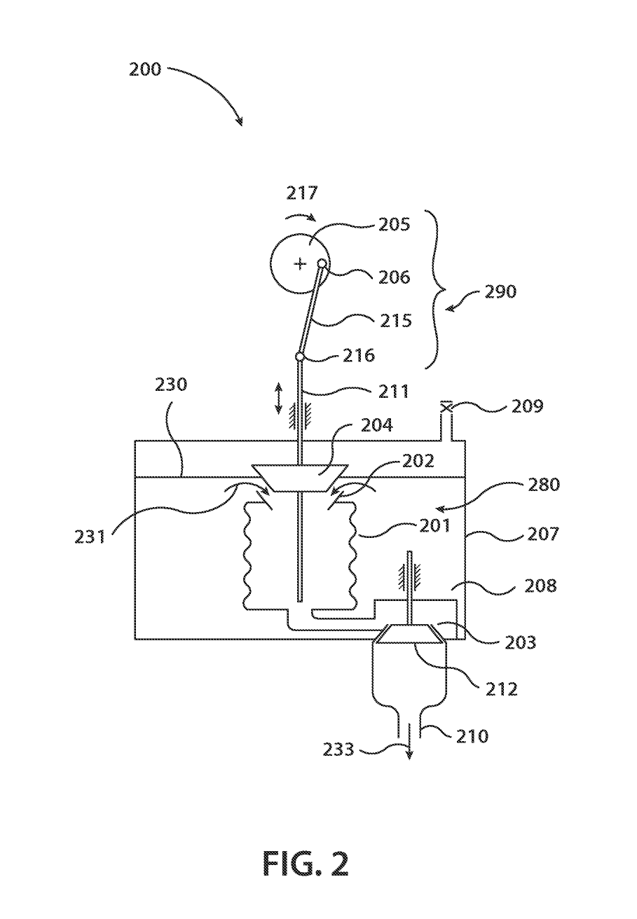

Referring now to FIG. 2, there is shown a pumping unit 200 consistent with an embodiment of the present invention. The pumping unit 200 includes driving section 290, a container 207, and pumping section 280. Relief valve 209 allows evaporation of the cryogenic fluid 208, and maintains atmospheric pressure (or pressure slightly above atmospheric pressure) in the container 207.

The driving section 290 is similar or identical to driving section 190 that was depicted in FIG. 1.

In contrast to pumping section 180 of FIG. 1, wherein outlet plug 112 is connected to, and operated by follower 111, controlling plug 212 which is capable of closing outlet valve seat 203 is not operated by follower 211 but instead it is responding to differences in cryogen pressures within bellows 201 and outlet 210. Alternatively, controlling plug 212 is operated electrically in synchronization with the rotation of wheel 205.

In operation, as the wheel 205 turns, for example in direction 217, such that bearing 206 is moving up, the link 215 which is connected to wheel 205 via bearing 206, forces the follower 211, which is connected to ling 215 via bearing 216, to move up. Follower 211 pulls inlet plug 204 upwards such that inlet opening 202 is opened and cryogen 208 having level 230 above inlet opening 202 enters 231 bellows 201 by gravitational force due to the condition of communicating vessels created between inner volume of bellows 201 and container 207. During this refilling stage of the pumping cycle, controlling plug 212 closes exit opening 203 due to one or combination of the following:

1) The cryogen pressure in outlet 210 is greater than the pressure in the container 207. This may be caused by flow resistance in the path of the pumped cryoliquid exiting outlet 210, or by evaporation of cryogen in the cryosurgical device connected to outlet 210. The difference in pressures forces controlling plug 212 against outlet valve seat 203;

2) A spring (not seen in this figure) may be used for overcoming gravity and forcing controlling plug 212 against outlet opening 203;

3) Controlling plug 212 may be made such that its specific gravity is lower than the cryoliquid such that it floats on cryogen in outlet 210 and is pushed against outlet opening 203; and

4) Controlling plug 212 may be electrically operated, for example using a solenoid (not shown), in synchronization with the rotation of 205.

As wheel 205 continues to turn such that bearing 206 reaches its highest position and starts to descend, follower 211 pushes down inlet plug 204, closing inlet valve seat 202. As follower 211 continues to descend, bellows 201 is compressed under the pressure of inlet plug 204 and the cryogen the bellows forces open controlling plug 212 and flows 133 through outlet 210. Alternatively, controlling plug 212 is electrically opens to allow cryogen flow 133 through outlet 210.

As wheel 205 continues to turn such that bearing 206 reaches its lowest position and starts to ascend, the refilling of bellows 201 is repeated. During the ascent of inlet plug 204 bellows 201 expand due to its flexibility to accept the inflow 231 of cryogen 208.

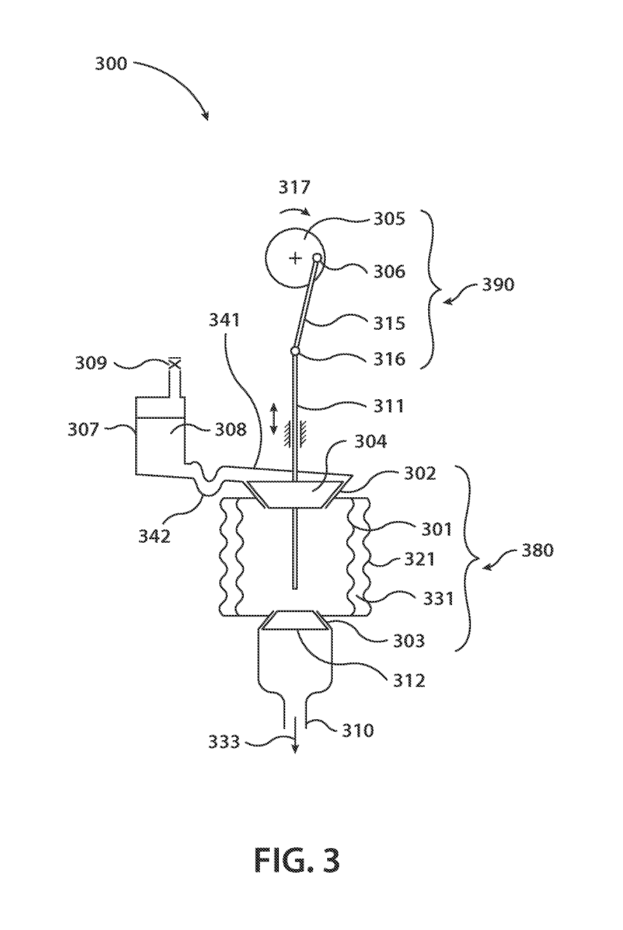

Referring now to FIG. 3, there is illustrated a pumping unit 300 consistent with an embodiment of the present invention.

The driving section 390, which is similar or identical to driving sections 190 and 290 disclosed above includes: a rotating wheel 305 connected to a link 315 via a bearing 306 at an end of the link; and a follower 311 connected to another end of the link 315 via a bearing 316.

The pumping section 380 includes: an inlet plug 304, an inner bellow 301, an outer bellow 321, and an outlet plug 312 and is driven by the reciprocal motion of follower 311.

The pumping unit 300 differs from the pumping units 100 and 200 of FIGS. 1 and 2, respectively, in that the pumping unit 300 includes a double bellows (i.e., inner bellow 301 and outer bellow 321, with vacuum in the space 331 between them to thermally insulate the cryogen in the inner bellows 301 from the environment. In this case, the bellows 301 and 321 are not immersed in the container 307 filled with cryogen 308. Relief valve 309 allows evaporation of the cryogenic fluid 308, and maintains atmospheric pressure (or pressure slightly above atmospheric pressure) in the container 307. The filling of the inner bellow by the law of communicating vessels is permitted by fluid connection 341. The flexible connection 342 permits the relative motion of the valve seat 302 which is connected to the bellows 301, and 321, and the cryogen container 307, while container 307, and outlet 310 with outlet valve seat 303, and driving section 390 are fixed to the body of pumping unit 300.

In the exemplary embodiment depicted in FIG. 3, outlet plug 312 is connected to, and operated by follower 311 to allow flow 133 of cryogen through outlet 310. This operation is a similar to the operation of outlet plug 112 depicted in FIG. 1. Alternatively, outlet plug 312 may operate similarly to the operation of plug 212 depicted in FIG. 2, that is: outlet plug 312 may be operated electrically in synchronization with the rotation of wheel 305; or outlet plug 312 may be responding to differences in cryogen pressures within bellows 301 and outlet 310.

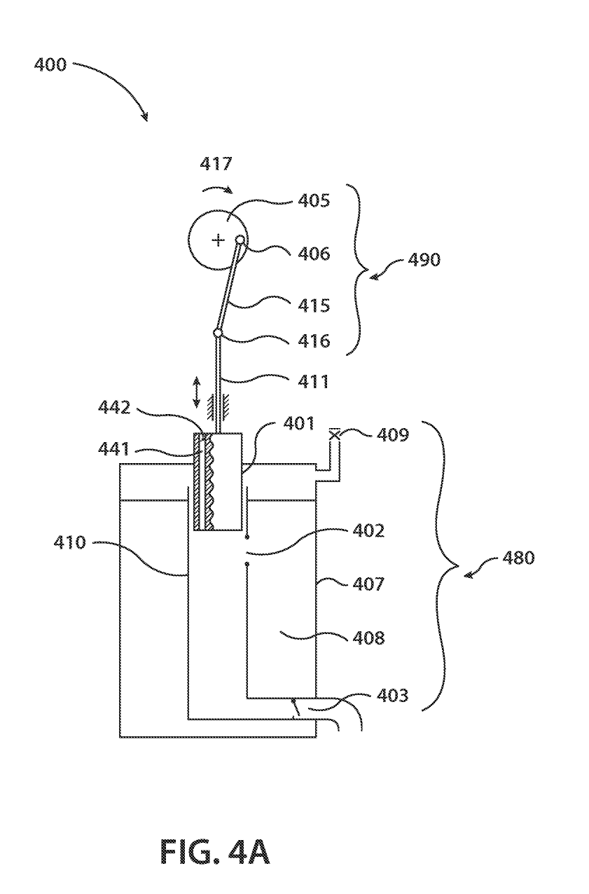

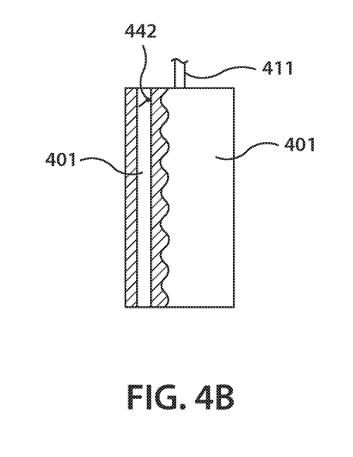

FIG. 4A schematically illustrates a cross sectional view of a pumping unit 400 consistent with an exemplary embodiment of the present invention.

The pumping unit 400 includes: a driving section 490; a container 407; and a pumping section 480. Relief valve 409 maintains atmospheric pressure in the container 407 filled with cryogenic fluid 408, to permit the filling of the bellow by the law of communicating vessels.

The driving section 490 includes: a rotating wheel 405 connected to a link 415 via a bearing 406 at an end of the link; and a follower 411 connected to another end of the link 415 via a bearing 416.

The pumping section 480 includes a piston 401 that travels reciprocally within a cylinder 410 and that is driven by the reciprocal motion of follower 411.

In operation, as the wheel 405 turns in direction 417, the link 415 forces the follower 411 to move cyclically in up and down directions. As piston 401, which is connected to follower 411 moves down from its upmost position, it closes the opening 402 in cylinder 410, stopping the filling of the cylinder 410 with cryogen 408 through opening 402 which is below the level 430 of cryogen 408 in container 407, by law of communicating vessels. As the follower continues to move downwards toward a position of maximum displacement, the piston presses the cryogen in the cylinder 410 to exit through the check valve 403.

After the follower has reached its lowest position and is moving up, valve 442 in piston 401 opens, letting air flow through tunnel 441 in piston 401, and compensate for the low pressure created by the movement, i.e. preventing vacuum pressure to be generated in cylinder 410 under piston 401.

Alternatively, the tunnel 442 and valve 441 may be omitted and the small gap between piston 401 and cylinder 410 may be configured to allow some gas flow into the cylinder 410. Same small gap between piston 401 and cylinder 410 is small enough to prevent excessive escape of cryogenic liquid during the down motion of the piston due to the higher viscosity of liquid in relation to the viscosity of gas. Additionally or alternatively, partial vacuum is generated in the cylinder 410 below piston 401 when piston 401 is moving up. This partial vacuum is partially filled with vapor of cryogenic left in the bottom of cylinder 410 and near check valve 403.

When piston 401 moves up, the inlet 402 is exposed to the cryogen 408 in the container 407 allowing the fluid to fill the cylinder through inlet opening 402, replacing any air that enter the cylinder 410, or vapor generated in it during the first part of the movement upwards.

FIG. 4B schematically illustrates enlarged cross sectional view of piston 401 showing tunnel 441, valve 442, and part of follower 411 according to the exemplary embodiment of the present invention depicted in FIG. 4A.

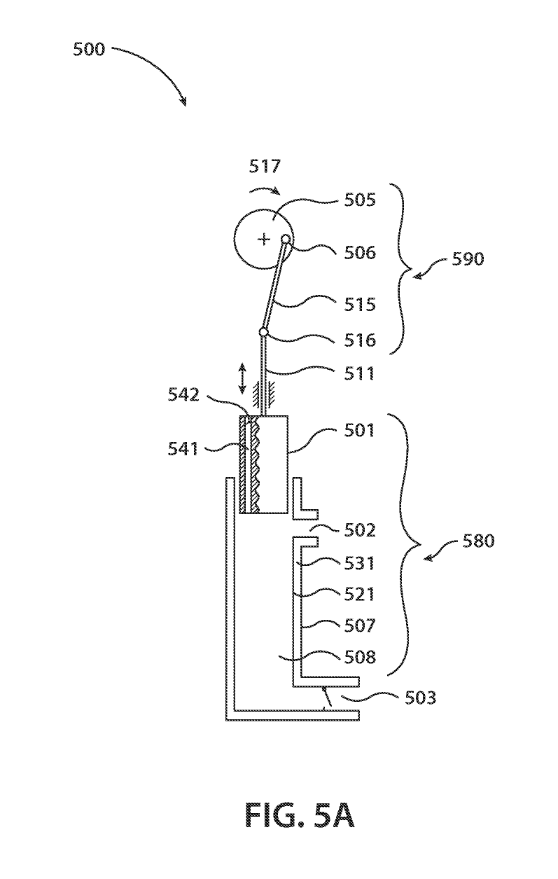

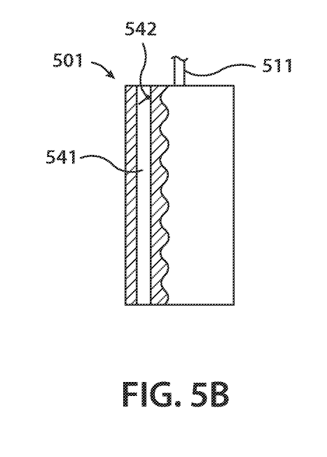

FIG. 5A, schematically illustrates a pumping unit 500 consistent with an exemplary embodiment of the present invention. The pumping unit 500 includes driving mechanism 590 and a pumping element 580.

The driving section 590 includes: a rotating wheel 505 connected to a link 515 via a bearing 506 at an end of the link; and a follower 511 connected to another end of the link 515 via a bearing 516.

The pumping section 580 includes a piston 501 that travels reciprocally within a cylinder 510 and that is driven by the reciprocal motion of follower 511. Cylinder 510 is a double walled cylinder with an outer wall 507 and an inner wall 521. The two walls 507 and 521 of cylinder 510 are separated by vacuum space 531 for thermal insulation.

Opening 502 in cylinder 510 is connected to a container (not shown) with cryogen.

Pumping unit 500 operates the same as system 400 seen in FIG. 4A. The link 515 forces the follower 511 to move in up and down directions. A piston 501 connected to follower 511 closes the opening 502 as it moves down, stopping the filling of the cylinder 510 with cryogen through opening 502, by law of communicating vessels. As the follower continues to move downwards, the piston presses the cryogen in the cylinder 510 to exit through the check valve 503. When the follower is moving up, the inlet 502 is exposed to the cryogen allowing the cryogenic fluid to fill the cylinder 510 through inlet opening 502.

After the follower has reached its lowest position and is moving up, valve 542 in piston 401 opens, letting air flow through tunnel 541 in piston 501, and compensate for the low pressure created by the movement (i.e. preventing vacuum pressure to be generated in cylinder 510 under piston 501).

Alternatively tunnel 542 and valve 541 are missing. Instead, the small gap between piston 501 and cylinder 510 allows some gas flow into the cylinder 510. Same small gap between piston 401 and cylinder 510 is small enough to prevent excessive escape of cryogenic liquid during the down motion of the piston 501 due to the higher viscosity of liquid in relation to the viscosity of gas. Additionally or alternatively, partial vacuum is generated in the cylinder 510 below piston 501 when piston 501 is moving up. This partial vacuum is partially filled with vapor of cryogenic left in the bottom of cylinder 510 and near check valve 503.

When piston 501 moves up, the inlet 502 is exposed to the cryogen in the container (not shown) allowing the fluid to fill the cylinder 510 through inlet opening 502, replacing any air that enter the cylinder 510, or vapor generated in it during the first part of the movement upwards.

FIG. 5B schematically illustrates an enlarged cross sectional view of piston 501 showing optional tunnel 541, valve 542, and part of follower 511 according to the exemplary embodiment of the present invention depicted in FIG. 5A.

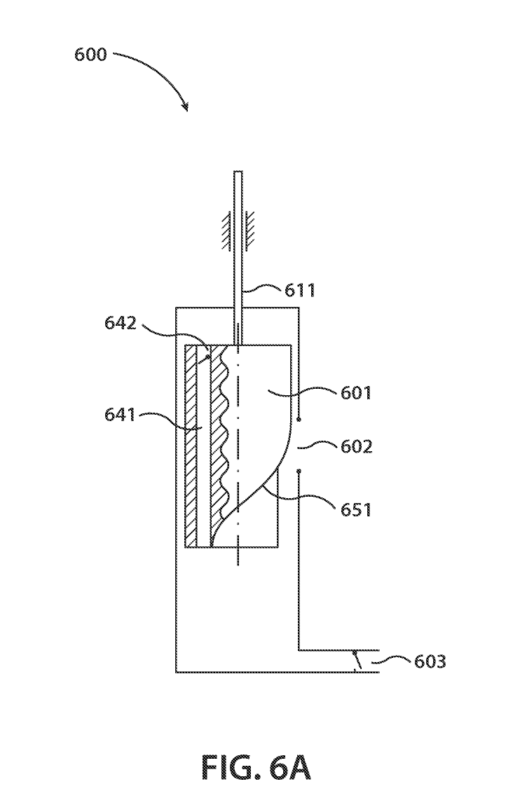

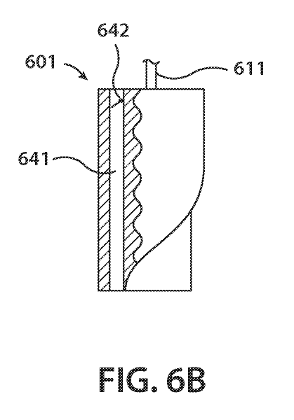

FIG. 6A schematically illustrates a cross sectional view of a pumping unit 600 using a piston 601 with a groove 652 according to an exemplary embodiment of the present invention.

Pumping unit 600 using a piston 601 with a groove 652 is an optional configuration that may be used in pumping units 400 and 500 of FIGS. 4A and 5A, respectively. The piston 601 is configured to include a groove 651 that permits, by rotating the piston 601 to select position of the piston in relationship with the opening 602, in which opening 602 is closed as the piston moves down, thus selecting the amount of the cryogen that is pressed to the exit valve 603.

The orientation of piston 601 may be preset during manufacturing or calibrating or adjusting the pumping unit. Optionally, additionally or alternatively, the orientation of the piston may be changed by rotating follower 611, which connected to the piston 611. For example, follower 611 may comprise a manual or motorized actuator allowing changing the rotational orientation of the piston 601 relative to opening 602, optionally while the pumping unit is assembled or in operation.

After the follower has reached its lowest position and is moving up, valve 642 in piston 601 opens, letting air flow through tunnel 641 in piston 601, and compensate for the low pressure created by the movement, i.e. preventing vacuum pressure to be generated in the cylinder 610 under piston 601.

Alternatively tunnel 642 and valve 641 are missing. Instead, the small gap between piston 601 and cylinder 620 allows some gas flow into the cylinder 510. Same small gap between piston 401 and cylinder 610 is small enough to prevent excessive escape of cryogenic liquid during the down motion of the piston 501 due to the higher viscosity of liquid in relation to the viscosity of gas. Additionally or alternatively, partial vacuum is generated in the cylinder 610 below piston 601 when piston 601 is moving up. This partial vacuum is partially filled with vapor of cryogenic left in the bottom of cylinder 610 and near check valve 603.

When piston 601 moves up, the inlet 602 is exposed to the cryogen in the container (not shown) allowing the fluid to fill the cylinder 610 through inlet opening 602, replacing any air that enter the cylinder 610, or vapor generated in it during the first part of the movement upwards.

FIG. 6B schematically illustrates enlarged cross sectional view of piston 601 showing optional tunnel 641, valve 642, and part of follower 611 according to the exemplary embodiment of the present invention depicted in FIG. 6A.

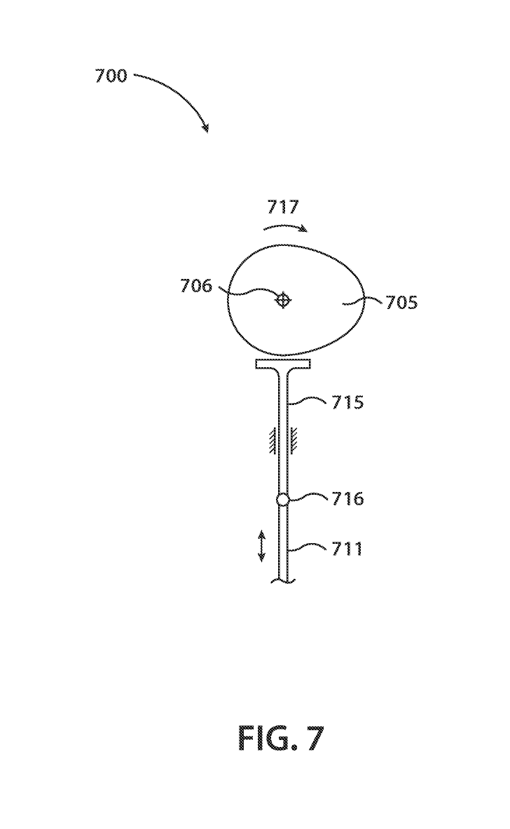

FIG. 7 illustrates an alternative driving section 700 that may optionally replace the driving sections in any of pumping units 100, 200, 300, 400, and 500 of FIGS. 1-3, 4A and 5A, respectively. The driving section 700 includes a cam 705 instead of a wheel. The cam 705 rotates in direction 717 around its pivot 706 and, because of its shape, drives a follower 715 reciprocally toward and away from the cam resulting in translation of the rotational motion of the cam 705 into reciprocating linear motion of the follower 715. The follower 715 is optionally connected to follower 711 via a pivot 716. The follower 711, in turn, may drive either a piston or a bellows. Followers 715 or 711 may act as followers 111, 211, 311, 411, 511 and 611 in FIGS. 1-3, 4A, 5A, and 6A, respectively.

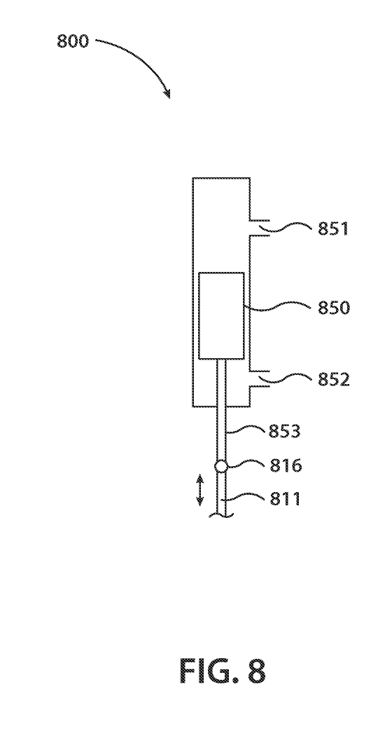

FIG. 8 illustrates pneumatic system, another alternative driving section 800, which may optionally replace driving section 190, 290, 390, 490, 590 or driving section 700. Pneumatic driving system 800 may optionally be used in any of pumping units 100, 200, 300, 400, and 500 of FIGS. 1-3, 4A, and 5A, respectively. The pneumatic driving section 800 includes a piston 850 instead of a wheel or cam. With this configuration, there is no need to translate rotational motion into reciprocating linear motion. The piston 850 moves up and down depending on the pneumatic pressure supplied at either opening 851 for motion downwards, or at opening 852 for motion upwards. In operation, a link 853, which is attached to an end of piston 850 optionally, pushes the optional follower 811 through optional pivot 816. Follower 811, or link 853 in turn, drives the pumping section. Pneumatic pressure is supplied by a gas pressure source and controlling valves as known in the art, which are not seen in this figure. Alternatively, hydraulic power may be used. Follower 811 or link 853 may act as followers 111, 211, 311, 411, 511 611 and 711 (or 715) in FIGS. 1-3, 4A, 5A, 6A and 7, respectively.

As described above, embodiments of the present invention provide a cryogen pump with unique control of the inlet and outlet flow. The system includes either a bellow pump or piston pump. The pump is either submerged in cryogenic fluid, or vacuum insulated. The inlet of the fluid is applying the law of communicating vessels, eliminating the need for an inlet valve.

Also, as described above, the cryogen pumps of embodiments of the present invention simplify the handling of the boiling fluid by either insulating it from the environment with vacuum insulation, or submerging the pumping unit in the bath of boiling fluid. In addition the inlet uses the natural law of communicating vessels, eliminating the need for a check valve and smoothing the operation. The motion distance of the connecting lever from the crank and the diameter of the crank position also can be used to make the pump metering pump. The pump can raise the pressure of the cryogens from atmospheric pressure or below to 40 at. The control of the pressure and the flow can be achieved by either changing the speed of the motion of the pump or change in the displacement of the pressing element.

All the elements of the disclosed systems may be made from material suitable to withstand the low temperature and the function of the elements would not be compromised by the low temperature. The lowest design temperature is negative 220 degrees Celsius.

Examples of various features/aspects/components/operations have been provided to facilitate understanding of the disclosed embodiments of the present invention. In addition, various preferences have been discussed to facilitate understanding of the disclosed embodiments of the present invention. It is to be understood that all examples and preferences disclosed herein are intended to be non-limiting.

Although selected embodiments of the present invention have been shown and described individually, it is to be understood that at least aspects of the described embodiments may be combined.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

What is claimed is:

1. A cryogen pump, comprising:
a pump section that includes
a cylinder having an inlet opening in communication with a cryogen and an exit valve,
a piston configured to travel reciprocally in the cylinder along a travel axis therein between
a load condition in which the piston is at a position of minimum displacement and the cryogen flows into the cylinder via the inlet opening and
a compressing condition in which the piston is at a position of maximum displacement, cryogen does not flow into the cylinder, and cryogen in the cylinder is compressed and pressed out of the exit valve; and
a drive section configured to drive the pump section in a reciprocating manner so as to move the piston.

2. The pump of claim 1, wherein the cylinder is a double walled cylinder with two walls, the walls being separated by a vacuum space that insulates an interior one of the walls.

3. The pump of claim 1, wherein the drive section translates rotational motion into reciprocating, linear motion that is communicated to the piston.

4. The pump of claim 1, wherein the drive section includes a pneumatic piston that yields reciprocating, linear motion that is communicated to the piston.
